(19) United States
(12) Patent Application Publication
(10) Pub. No.: US 2025/0209519 A1
(43) Pub. Date: Jun. 26, 2025

(54) EVENT-DRIVEN SUBSCRIPTION ORDER MODIFICATION

(71) Applicant: Motorola Mobility LLC, Chicago, IL (US)

(72) Inventors: Amit Kumar Agrawal, Bangalore (IN); Renuka Prasad Herur Rajashekaraiah, Bangalore (IN); Srikanth Ramaraju, Sahakaranagar (IN)

(73) Assignee: Motorola Mobility LLC, Chicago, IL (US)

(21) Appl. No.: 18/389,959

(22) Filed: Dec. 20, 2023

(51) Int. Cl. G06Q 30/0601

(52) U.S. Cl. CPC G06Q 30/0635

(57) ABSTRACT

In aspects of event-driven subscription order modification, a mobile device transmits a subscription order to a fulfillment service for one or more items. A server device receives, from the mobile device, the subscription order for the one or more items. The mobile device and/or the server device determine an event that affects a quantity of an item included in the subscription order. The mobile device transmits, to the fulfillment service (e.g., of the server device), a request to modify the quantity of the item included in the subscription order based on the determination of the event. Additionally, or alternatively, the server device transmits, to the mobile device, a request to modify the quantity of the item included in the subscription order based on the determination of the event.

### BACKGROUND

Shopping applications are part of the broader context of online digital services, where services are provided over the Internet. Shopping applications provide the ability for users to place orders through Internet-connected computing devices such as mobile phones, tablets, laptops, desktop computers, and televisions. Shopping applications include application programing interfaces (APIs) that enable cross-institutional services that provide services and transactions worldwide, any day of the week, at any time of day. The shift from traditional shopping to online shopping has been gradual and remains ongoing. Shopping applications offer varying levels of automation and web-based services, including subscription services that includes regular and/or scheduled delivery of subscribed items.

### BRIEF DESCRIPTION OF THE DRAWINGS

Implementations of the techniques for event-driven subscription order modification are described with reference to the following Figures. The same numbers may be used throughout to reference like features and components shown in the Figures.

FIG. 1 illustrates an example system for event-driven subscription order modification in accordance with one or more implementations as described herein.

FIG. 2 further illustrates a process flow diagram of event-driven subscription order modification in accordance with one or more implementations as described herein.

FIGS. 3-5 illustrate example methods for event-driven subscription order modification in accordance with one or more implementations of the techniques described herein.

FIG. 6 illustrates various components of an example device that may be used to implement the techniques for event-driven subscription order modification as described herein.

### DETAILED DESCRIPTION

Implementations of the techniques for event-driven subscription order modification may be implemented as described herein. A mobile device such as any type of a wireless device, mobile phone, flip phone, client device, wearable computing device, tablet computing device, communication device, entertainment device, gaming device, media playback device, and/or any other type of computing, consumer, and/or electronic device, or a system of any combination of such devices, may be configured to perform techniques for event-driven subscription order modification as described herein. In some cases, at least one device (e.g., a mobile device, a server device) implements an instantiation of a smart order controller, enabling the smart subscription order modification functionality described herein.

With a single click, a user can shop, track, and change online orders, including subscription plans. However, online ordering and subscription plans have some drawbacks such as food waste that results from scheduled events, unexpected circumstances, and a situational inability to consume a perishable item before it expires. In some cases, a user may forget to pause a subscription based on one or more circumstances. For example, a user may neglect to pause a subscription with perishable items based on personal excursions, unanticipated trips, illness, temporal dietary restrictions (e.g., fasting days, doctor orders, diet restriction against dairy products, etc.).

A device (e.g., mobile device, server device) enabled with the smart subscription order modification functionality of the smart order controller can assist such users in better managing subscriptions and dietary constraints in order to reduce food and money waste. For example, the device enabled with the smart order controller may modify (e.g., autonomously modify without user input) subscriptions based on a planned travel, unplanned travel, extending travel, planned visitors, unplanned visitors, sickness, fasting days, doctor orders, and the like. The device enabled with the smart subscription order modification functionality may track a cutoff time for modifying a subscription and modify the subscription (e.g., one or more subscriptions) as long as the modification occurs before the cutoff time.

In one example, a user may determine that special tickets for an event are available. The user may immediately call family, receive confirmation, and purchase the tickets. The user may book a hotel based on the location of the ticketed event. The user may travel to the location of the event with family, spend the allocated time at the location, and then return home. When the user returns, the user and family realize that fruit juice, bread, milk, and eggs from an order (e.g., a subscription order) were delivered while they were at the event, and that the items have spoiled at the front door. The perishable items and the money spent on the perishable items are wasted. Similarly, a user schedules a trip ahead of time, plans the trip, and leaves on vacation. While the user is away, items from an order that include perishable items are delivered just outside the front door of the user's apartment. Since the user is not there to bring in the items, apartment housekeeping takes away all of the items. Once again, the perishable items and the money spent on the perishable items are wasted.

In aspects of the described techniques, a smart order controller implements smart subscription order modification functionality to enable modification of orders (e.g., autonomous modification without user input) based on the user's circumstances ranging from personal excursions, unanticipated trips, illness, dietary restrictions (e.g., fasting days). In one or more examples, the smart subscription order modification functionality is performed via a mobile device that implements an instantiation of a smart order controller.

In one or more examples, the smart order controller may determine a user's context (e.g., user circumstances, user events in relation to one or more orders). In some cases, the smart order controller may identify one or more events associated with the user in relation to one or more orders of the user. The events may include upcoming travel based on a purchase of flight tickets, hotel accommodation, receiving an itinerary from an email, receiving an event invitation, receiving a calendar update, and the like. In some cases, the events may include a user's health based on a hospital visit, receiving at least a portion of a doctor record of the user, receiving a prescription from a doctor, detecting in a text message indicating the user is sick, detecting in a phone call that the user is sick, and the like. In some cases, the events may include user's dietary customs, user's fasting requirements (e.g., fasting days that occur, a schedule of fasting days, etc.).

In one or more examples, the smart order controller may identify one or more orders (e.g., daily subscription of perishable items, etc.). In some cases, the smart order controller may identify a schedule of a subscription (e.g., daily, weekly, specific dates, etc.) and that the user's subscription includes perishable items. Additionally, or alternatively, the smart order controller may notify the user that the subscription (e.g., one or more subscriptions) will be paused for an indicated time (e.g., until the user's context is detected to have returned to a default context).

In one or more examples, the smart order controller may monitor the user's context (e.g., ongoing monitoring of user's circumstances). In some cases, the smart order controller may determine whether the user's trip plans have been extended (e.g., by confirming the current location of the user and estimating the earliest possible arrival time). Additionally, or alternatively, the smart order controller may notify the user that the subscription (e.g., one or more subscriptions) will be paused until the user returns home. In some cases, the smart order controller may determine whether the user forgets to pause a subscription and display a prompt suggesting that the user pause the subscription. In some cases, the prompt may be displayed based on a cutoff time. For example, the prompt may indicate a specified time and state that orders may be updated up until the specified time.

In one or more examples, the smart order controller may resume subscription services. For example, the smart order controller may resume a subscription (e.g., one or more subscriptions) based on the user's context (e.g., based on a determination that the user has returned home, that the user is feeling well, that the user is no longer under dietary restrictions, etc.).

In implementations, the smart order controller is implemented at least partially in hardware and configured to cause a mobile device to transmit a subscription order with a fulfillment service for one or more items. The smart order controller may determine an event that affects a quantity of an item included in the subscription order (e.g., user's context). In some cases, the smart order controller may transmit, to the fulfillment service, a request to modify the quantity of the item included in the subscription order based on the determination of the event.

Implementations of the techniques for event-driven subscription order modification include multiple advantages and benefits. For example, the smart subscription order modification functionality of the smart order controller enables a device to determine an upcoming unavailability or inability to consume items of a subscription that includes perishable items and autonomously pauses the subscription until determining that the user's context returns to a normal or default state. As a result, the smart order controller prevents perishable items from going to waste. Also, the smart order controller prevents money being wasted on orders that a user would like to pause.

While features and concepts of the described techniques for event-driven subscription order modification are implemented in any number of different media devices, systems, environments, and/or configurations, implementations of the techniques for event-driven subscription order modification are described in the context of the following example devices, systems, and methods.

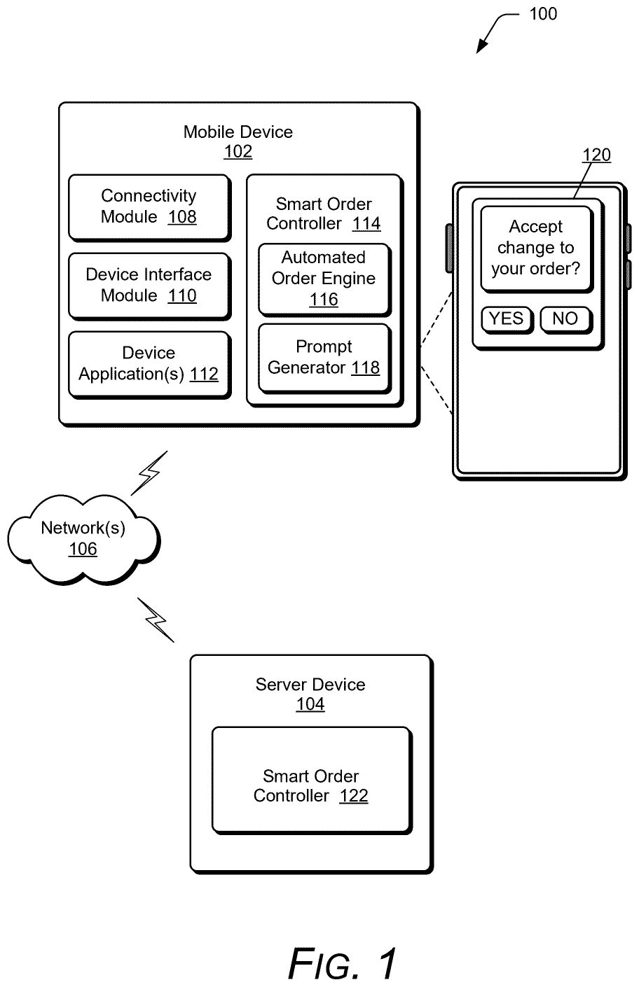

FIG. 1 illustrates an example system 100 for event-driven subscription order modification, as described herein. The system 100 includes one or more devices, such as a mobile device 102 and/or a server device 104. Examples of mobile devices include at least one of any type of a wireless device, mobile device, mobile phone, flip phone, client device, game controller, wearable computing device, camera device, display device, tablet, computing device, communication device, entertainment device, gaming device, media playback device, any other type of computing, consumer, and/or electronic device, and/or a system of any combination of such devices.

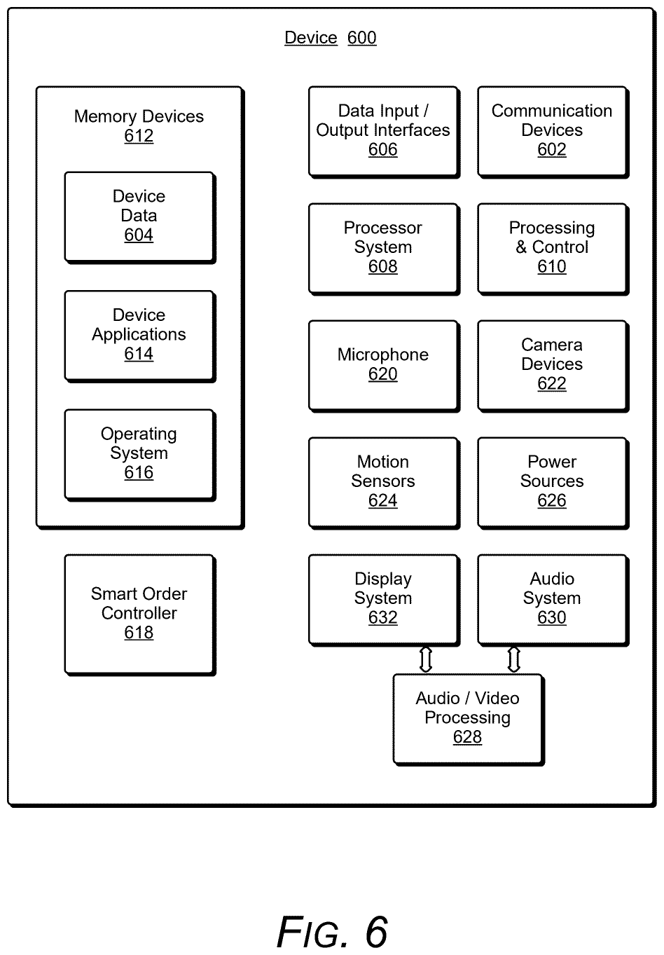

The mobile device 102 is implemented with various components, such as a processor system and memory, as well as any number and combination of different components as further described with reference to the example device shown in FIG. 6. In implementations, the mobile device 102 includes various radios for wireless communication with other devices. In one or more examples, the mobile device 102 includes at least one of a BLUETOOTH® (BT) or BLUETOOTH® Low Energy (BLE) transceiver, a near field communication (NFC) transceiver, or the like. In some cases, the mobile device 102 includes at least one of a WI-FI® radio, a cellular radio, a global positioning satellite (GPS) radio, or any available type of device communication interface.

Additionally, or alternatively, the system 100 includes a server device 104, such as any type of server, cloud computing device, computer, laptop device, desktop computer, tablet, wireless device, smart device, media device, display device, or any other type of computing device. Similar to the mobile device 102, the server device 104 is implemented with various components, such as a processor system and memory, as well as any number and combination of the different components as further described with reference to the example device shown in FIG. 6. In implementations, the mobile device 102 is communicatively linked, by a wired or wireless connection, to the server device 104. For example, the mobile device 102 and the server device 104 are communicatively linked via a communication network 106 and/or via direct inter-device connectivity, e.g., via direct wireless and/or wired connectivity between the mobile device 102 and the server device 104.

In some implementations, the devices, applications, modules, servers, and/or services described herein communicate via the communication network 106, such as for data communication between the mobile device 102 and the server device 104. The communication network 106 includes a wired and/or a wireless network. The communication network 106 can be implemented using any type of network topology and/or communication protocol, and is represented or otherwise implemented as a combination of two or more networks, to include IP-based networks, cellular networks, and/or the Internet. The communication network 106 can also include mobile operator networks that are managed by a mobile network operator and/or other network operators, such as a communication service provider, mobile phone provider, and/or Internet service provider.

The mobile device 102 includes various functionalities that enable the device to implement different aspects of event-driven subscription order modification, as described herein. In the illustrated example, the mobile device 102 includes a connectivity module 108, a device interface module 110, device applications 112, and a smart order controller 114. The connectivity module 108 represents functionality (e.g., logic, software, and/or hardware) enabling the mobile device 102 to interconnect with other devices and/or networks, such as the server device 104 and the communication network 106. For example, the connectivity module 108 enables wireless and/or wired connectivity of the mobile device 102. The device interface module 110 represents functionality enabling the mobile device 102 to interface with other devices. As further detailed below, the device interface module 110 enables the mobile device 102 to establish wireless and/or wired data communication with other devices, such as the server device 104.

Similarly, the server device 104 includes various functionality that enables the computing device to implement different aspects of event-driven subscription order modification, as described herein. Similar to the mobile device 102, the server device 104 can also be implemented to include a connectivity module and/or a device interface module to enable the server device 104 to communicate with one or more devices (e.g., the mobile device 102 and the communication network 106). As shown, the server device 104 may include a smart order controller 122, enabling the server device 104 to implement the techniques for event-driven subscription order modification described herein. In some cases, the server device 104 may provide a fulfillment service based on the smart order controller 122.

The mobile device 102 can include and implement device applications 112, such as any type of messaging application, email application, video communication application, cellular communication application, music/audio application, gaming application, media application, social platform application, and/or any other of the many possible types of device applications. Many of the device applications 112 have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102.

In the example system 100 for event-driven subscription order modification, the mobile device 102 and the server device 104 are devices that incorporate smart subscription order modification functionality. In some cases, the mobile device 102 can implement the smart order controller 114 (e.g., as a device application 112) and the server device 104 can implement the smart order controller 122 (e.g., as a device application of the server device 104). The smart order controller 114 and/or the smart order controller 122 represent functionality (e.g., logic, software, and/or hardware) enabling implementation of described techniques for event-driven subscription order modification. The smart order controller 114 and/or the smart order controller 122 can be implemented as computer instructions stored on computer-readable storage media and can be executed by a processor system of the mobile device 102 and/or of the server device 104, respectively. Alternatively or in addition, the smart order controller 114 and/or the smart order controller 122 can be implemented at least partially in hardware of a respective device.

In one or more implementations, the smart order controller 114 and/or the smart order controller 122 includes independent processing, memory, and/or logic components functioning as a computing and/or electronic device integrated with the mobile device 102 and/or with the server device 104, respectively. Alternatively or in addition, the smart order controller 114 and/or the smart order controller 122 can be implemented in software, in hardware, or as a combination of software and hardware components. In one or more examples, the smart order controller 114 and/or the smart order controller 122 is implemented as a software application or module, such as executable software instructions (e.g., computer-executable instructions) that are executable with a processor system of the mobile device 102 and/or the server device 104 to implement the techniques and features described herein. As a software application or module, the smart order controller 114 and/or the smart order controller 122 is stored on computer-readable storage memory (e.g., memory of a device), or in any other suitable memory device or electronic data storage implemented with the module. Alternatively or in addition, the smart order controller 114 and/or the smart order controller 122 is implemented in firmware and/or at least partially in computer hardware. For example, at least part of the smart order controller 114 and/or the smart order controller 122 is executable by a computer processor, and/or at least part of the smart order controller 114 and/or the smart order controller 122 is implemented in logic circuitry.

In the illustrated example, the smart order controller 114 includes an automated order engine 116 and a prompt generator 118. In some cases, the smart order controller 114 transmits a subscription order to a fulfillment service (e.g., server device 104) for one or more items. In some cases, the smart order controller 114 may determine an event that affects a quantity of an item included in the subscription order and transmit, to the server device 104, a request to modify the quantity of the item included in the subscription order based on the determination of the event. In some cases, modifying the order can include adding a new item to the order, removing an item from the order, reducing an amount of an item, and/or increasing an amount of an item, etc.

In some cases, the determination that the event affects the quantity of the item is based on the item being perishable. In one or more examples, the smart order controller 114 can initiate to modify the quantity of the item included in the subscription order based on the event including a social event in which more people will use or consume the item, or less people will use or consume the item. For example, the event may include or may be based on a guest visit, a guest overnight stay, a number of guests at a meal, a number of guests staying overnight, and/or a number of nights each guest is staying overnight. In some cases, the smart order controller 114 causes the mobile device 102 to modify the quantity of an item included in the subscription order based on the event including more people who will use or consume the item, or less people who will use or consume the item. In some cases, the number of guests can be based on an alteration or change in the number of guests, the number of nights, etc.

In some examples, the smart order controller 114 causes the mobile device to modify the quantity of the item included in the subscription order based on the event including upcoming scheduled travel, extended travel days, or reduced travel days. In some cases, the smart order controller 114 causes the mobile device 102 to modify the quantity of the item included in the subscription order based on a current geographic location of a delivery recipient relative to a delivery location of the subscription order and/or based on an estimation of an arrival time of the delivery recipient to the delivery location based on the current geographic location of the delivery recipient.

In some cases, the smart order controller 114 causes the mobile device 102 to modify the subscription order based on the event including a detected health issue of a delivery recipient (e.g., illness, medical dietary restrictions), a detected prescription to remove or add the item for consumption, and/or a detected dietary change of the delivery recipient (e.g., a fasting day).

In some cases, the smart order controller 114 causes the mobile device 102 to modify the subscription order based on the event including an ability of payment for the subscription order. For example, the smart order controller 114 may determine that a balance of a payment account associated with the order has insufficient funds for the order (e.g., an account balance associated with paying for the order, an available credit to pay for the order, insufficient funds to pay for the order). Accordingly, the smart order controller 114 may modify the order to ensure that there are sufficient funds for the items ordered (e.g., item amount, item quantity).

In some cases, the smart order controller 114 causes the mobile device 102 to permit transmission of the request to modify the quantity of the item included in the subscription order based on a determination that the transmission occurs prior to a cutoff time for modifying orders on the fulfillment service. For example, the smart order controller 114 may determine that the cutoff time is 9:00 PM the following day. Accordingly, the smart order controller 114 may the request to modify the subscription order to be transmitted as long as the request is sent prior to 9:00 PM on the following day.

In some cases, the smart order controller 114 causes the mobile device 102 to permit transmission of the request to modify the quantity of the item included in the subscription order based on an approval from a delivery recipient in response to a notification and request to modify the subscription order. As shown, the prompt generator 118 may generate and display the prompt 120 requesting that a change to the order be accepted. When the smart order controller 114 detects that the user accepts the change based on user input (e.g., detecting the user pressing the example YES button of the prompt 120), then the smart order controller 114 proceeds with requesting the modification.

In some cases, the smart order controller 114 causes the mobile device 102 to revert the subscription order to include default items and/or a respective default quantity of the default items based on a determination that the event no longer affects the subscription order and that sufficient time remains to modify the subscription order (e.g., the request may be submitted before the cutoff time).

Similar to the smart order controller 114 implemented by the mobile device 102, the smart order controller 122 implemented at the server device 104 may include an automated order engine and/or a prompt generator. In some cases, the smart order controller 122 may be implemented at least partially in hardware and configured to cause the server device 104 to receive, from the mobile device 102, a subscription order for one or more items. In some cases, the smart order controller 122 may determine an event that affects a quantity of an item included in the subscription order and transmit, to the mobile device 102, a request to modify the quantity of the item included in the subscription order based on the determination of the event. In some cases, the determination that the event will affect the quantity of the item is based on the item being perishable.

In some examples, the smart order controller 122 causes the server device 104 to modify the quantity of the item included in the subscription order based on the event including more people who will use or consume the item, or less people who will use or consume the item. In some cases, the smart order controller 122 can modify the quantity of the item included in the subscription order based on the event including upcoming scheduled travel, extended travel days, and/or reduced travel days, etc.

In some examples, the smart order controller 122 causes the server device 104 to modify the quantity of the item included in the subscription order based on at least one of a current geographic location of a delivery recipient relative to a delivery location of the subscription order, and/or an estimation of an arrival time of the delivery recipient to the delivery location based on the current geographic location of the delivery recipient. In some cases, the smart order controller 122 can modify the subscription order based on the event including a detected health issue of a delivery recipient, a detected prescription to remove or add the item for consumption, and/or a detected dietary change of the delivery recipient. the smart order controller 122 can also modify the subscription order based on the event including an ability of payment for the subscription order.

In some cases, the smart order controller 122 causes the server device 104 to revert the subscription order to include default items and/or a respective default quantity of the default items based on a determination that the event no longer affects the subscription order and that sufficient time remains to modify the subscription order (e.g., the request may be submitted before the cutoff time).

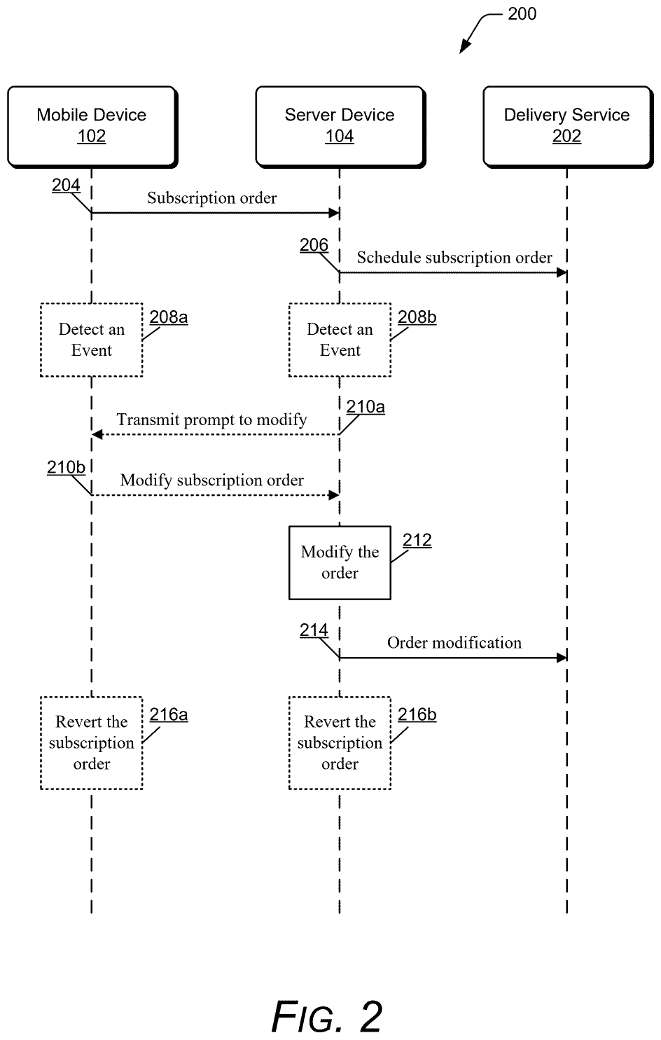

FIG. 2 further illustrates a process flow diagram 200 of event-driven subscription order modification in accordance with one or more implementations as described herein. As shown, the process flow diagram 200 includes the mobile device 102, the server device 104, and a delivery service 202. In some cases, at least a portion of the delivery service 202 may be provided by the server device 104. Additionally, or alternatively, at least a portion of the delivery service 202 may be provided by a third-party independent of the server device 104.

In one or more examples, the mobile device 102 may perform one or more operations of process flow diagram 200 in conjunction with the smart order controller 114. Additionally, or alternatively, the server device 104 may perform one or more operations of process flow diagram 200 in conjunction with the smart order controller 122 in order to provide a fulfillment service.

At 204, the mobile device 102 may transmit a subscription order to the server device 104. For example, the mobile device 102 may schedule a subscription order that provides a delivery of items on a set schedule.

At 206, the server device 104 may transmit a scheduled subscription order to the delivery service 202. For example, the server device may indicate a quantity of each item in the order, a type for each item (e.g., perishable item, non-perishable item) in the order, a schedule for delivering the order, and the like.

At 208a, the mobile device 102 may optionally identify an event and determine that the event that affects at least one item included in the subscription order. Additionally, or alternatively, at 208b, the server device 104 may identify the event and determine that the event affects at least one item included in the subscription order.

At 210a, the server device 104 may optionally transmit a prompt (e.g., prompt 120) to the mobile device 102 requesting approval to modify the subscription order (e.g., modify one or more items in the subscription order). In response, the mobile device 102 may transmit an approval of the request to the server device 104. At 210b, the mobile device 102 may optionally transmit, to the server device 104, a request to modify at least one item included in the subscription order based on the determination of the event. For example, instead of receiving a prompt from the server device 104 and responding to the prompt, the mobile device 102 may transmit the request to modify at least one item included in the subscription order independent of a message from the server device 104.

At 212, the server device 104 may modify the quantity of the item included in the subscription order based on the determination of the event. In some cases, the modification may include pausing the entire order. Alternatively, the modification may include adding an item, removing an item, reducing an amount of an item, and/or increasing an amount of an item.

At 214, the server device 104 may transmit an order modification to the delivery service 202. For example, the server device 104 may transmit a notification to the delivery service 202 indicating that the order has been modified. In some cases, the order modification message may include an item to add, an item to remove, an amount of an item to reduce, an amount of an item to increase, instructions to hold the order until further notice, and/or a new delivery date that replaces the original delivery date.

At 216a, the mobile device 102 may optionally revert the subscription order to include default items and a respective default quantity of the default items based on a determination that the event no longer affects the subscription order and that sufficient time remains to modify the subscription order (e.g., before the cutoff time). Additionally, or alternatively, at 216b, the server device 104 may optionally revert the subscription order to include default items and a respective default quantity of the default items based on a determination that the event no longer affects the subscription order and that sufficient time remains to modify the subscription order.

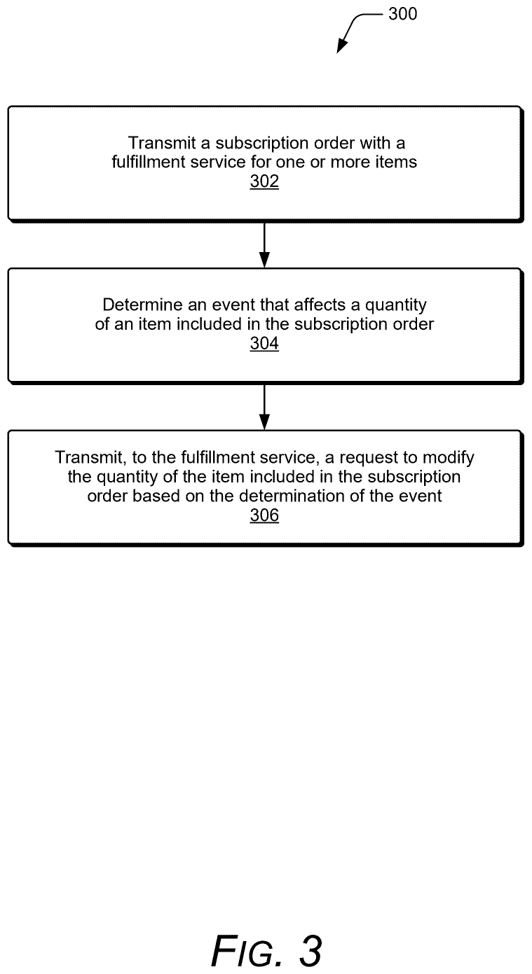

Example methods 300, 400, and 500 are described with reference to respective FIGS. 3, 4, and 5 in accordance with one or more implementations of event-driven subscription order modification, as described herein. Generally, any services, components, modules, managers, controllers, methods, and/or operations described herein can be implemented using software, firmware, hardware (e.g., fixed logic circuitry), manual processing, or any combination thereof. Some operations of the example methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

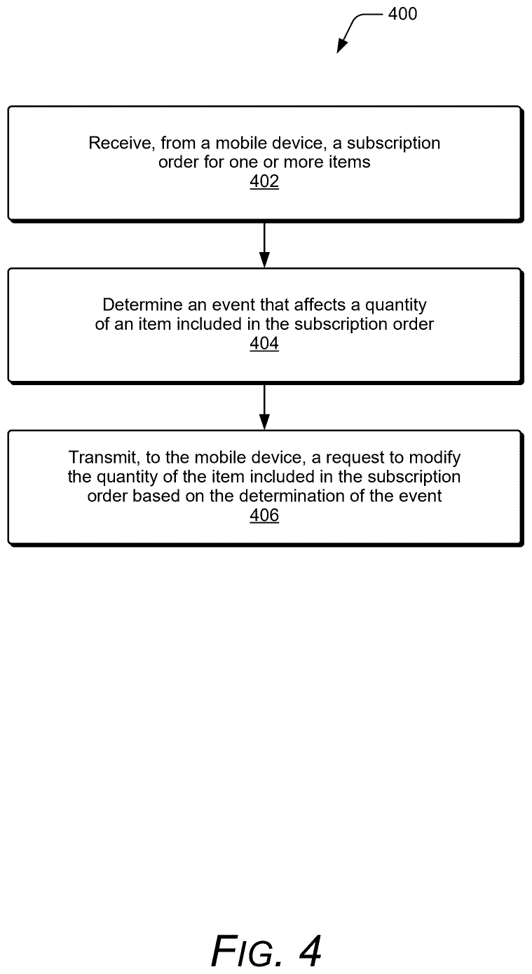

FIG. 3 illustrates example method(s) 300 for event-driven subscription order modification. The order in which the method is described is not intended to be construed as a limitation, and any number or combination of the method operations described herein (e.g., of FIGS. 3, 4, and/or 5) may be performed in any order to perform a method, or an alternate method.

At 302, a subscription order is transmitted to a fulfillment service for one or more items. For example, the smart order controller 114 of the mobile device 102 receives one or more items and a quantity of the one or more items for a subscription order, and transmits the subscription order to the server device 104.

At 304, an event that affects a quantity of an item included in the subscription order is determined. For example, the smart order controller 114 determines that an event such as user travel, user illness, dietary restrictions, etc., affects the subscription order.

At 306, a request to modify the quantity of the item included in the subscription order is transmitted to the fulfillment service based on the determination of the event. For example, the smart order controller 114 transmits a modification of the subscription order to the server device 104.

FIG. 4 illustrates example method(s) 400 for event-driven subscription order modification. The order in which the method is described is not intended to be construed as a limitation, and any number or combination of the method operations described herein (e.g., of FIGS. 3, 4, and/or 5) may be performed in any order to perform a method, or an alternate method.

At 402, a subscription order for one or more items is received from a mobile device. For example, the smart order controller 122 of the server device 104 receives a subscription order from the mobile device 102.

At 404, an event that affects a quantity of an item included in the subscription order is determined. For example, the smart order controller 122 determines that an event, such as user travel, user illness, dietary restrictions, etc., affects the subscription order.

At 406, a request to modify the quantity of the item included in the subscription order is transmitted to the mobile device based on the determination of the event. For example, the smart order controller 122 transmits to the mobile device 102 a request (e.g., the prompt 120) to modify the quantity of the item included in the subscription order based on the determination of the event (e.g., pause the entire order, modify an amount of an item, etc.).

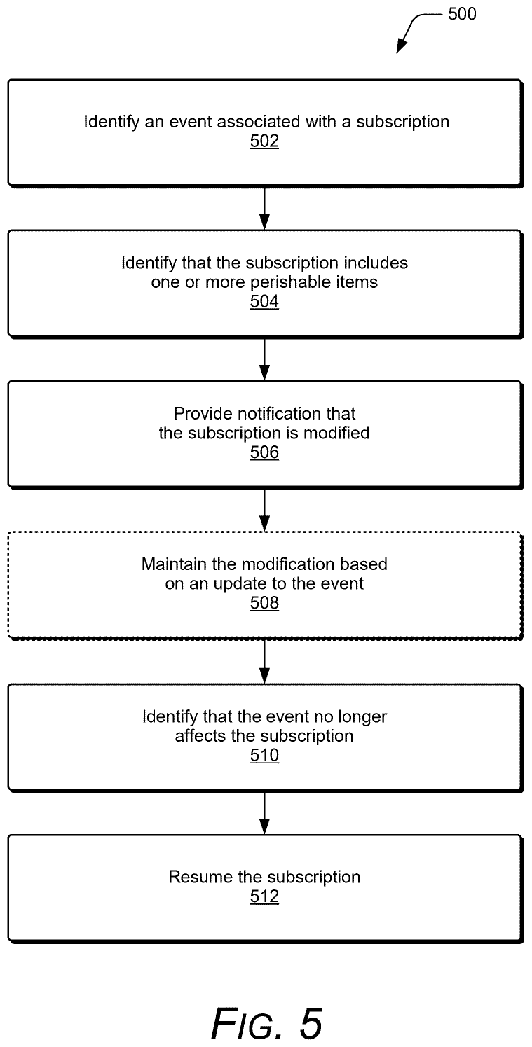

FIG. 5 illustrates example method(s) 500 for event-driven subscription order modification. The order in which the method is described is not intended to be construed as a limitation, and any number or combination of the method operations described herein (e.g., of FIGS. 3, 4, and/or 5) may be performed in any order to perform a method, or an alternate method.

At 502, an event associated with a subscription is identified. For example, the smart order controller 114 of the mobile device 102 and/or the smart order controller 122 of the server device 104 determines that at least one user associated with the event is traveling, is ill, is fasting, and/or is on a diet plan (e.g., on an altered diet).

At 504, a determination is made that the subscription includes one or more perishable items. For example, the smart order controller 114 and/or the smart order controller 122 determines that the subscription includes one or more perishable items that may be affected by the event.

At 506, notification that the subscription is modified is provided. For example, the smart order controller 114 and/or the smart order controller 122 may determine that the event affects one or more aspects of the subscription. Additionally, or alternatively, the smart order controller 114 and/or the smart order controller 122 may determine that the event puts the perishable items at risk of perishing. Accordingly, the smart order controller 114 and/or the smart order controller 122 may notify at least one user that the subscription is modified (e.g., modify a quantity of an item, increase an amount of an item, decrease an amount of an item, pause the subscription for an indicated period of time, etc.).

At 508, optionally, the modified subscription is maintained based on detecting an update to the event. For example, the smart order controller 114 and/or the smart order controller 122 determines that at least one user has extended a trip, still remains ill, is still fasting, and/or is still on a diet. Accordingly, the smart order controller 114 and/or the smart order controller 122 maintains the modification of the subscription. Additionally, or alternatively, the smart order controller 114 and/or the smart order controller 122 may further modify the subscription based on the update to the event (e.g., extend a pause of the subscription, extend the modification for an additional period of time, further modify a quantity of an item, increase an amount of an item, decrease an amount of an item, etc.)

At 510, a determination is made that the event no longer affects the subscription. For example, the smart order controller 114 and/or the smart order controller 122 determines that at least one user has returned home, has recovered from illness, is no longer fasting, and/or has resumed a regular diet.

At 512, the subscription is resumed. For example, the smart order controller 114 and/or the smart order controller 122 determines that the one or more perishable items of the subscription are no longer at risk due to the event (e.g., because the user has returned home, because the user is no longer sick, etc.). Accordingly, the smart order controller 114 and/or the smart order controller 122 resumes the subscription (e.g., resume delivery of subscribed items).

FIG. 6 illustrates various components of an example device 600, which can implement aspects of the techniques and features for event-driven subscription order modification, as described herein. The example device 600 may be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or the server device 104 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In one or more examples, the device 600 includes a smart order controller 618 that implements various aspects of the described features and techniques described herein. The smart order controller 618 is implemented with hardware components and/or in software as one of the device applications 614, such as when the example device 600 is implemented as the mobile device 102 and/or the server device 104 described with reference to FIGS. 1-5. An example of the smart order controller 618 is the smart order controller 114 implemented by the mobile device 102 and/or the smart order controller 122 implemented by the server device 104, such as a software application and/or as hardware components in the mobile device 102 and/or in the server device 104. In implementations, the smart order controller 618 includes independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for event-driven subscription order modification have been described in language specific to features and/or methods, the appended claims are not necessarily limited to the specific features or methods described. Rather, the specific features and methods are disclosed as example implementations for event-driven subscription order modification, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device, including: at least one processor coupled with a memory; and a smart order controller implemented at least partially in hardware and configured to cause the mobile device to: transmit a subscription order to a fulfillment service for one or more items; determine an event that affects a quantity of an item included in the subscription order; and transmit, to the fulfillment service, a request to modify the quantity of the item included in the subscription order based on the determination of the event.

In some aspects, the techniques described herein relate to a mobile device, wherein the determination that the event affects the quantity of the item is based on the item being perishable.

In some aspects, the techniques described herein relate to a mobile device, wherein the smart order controller is configured to cause the mobile device to modify the quantity of the item included in the subscription order based on the event including at least one of more people who will use or consume the item, or less people who will use or consume the item.

In some aspects, the techniques described herein relate to a mobile device, wherein the smart order controller is configured to cause the mobile device to modify the quantity of the item included in the subscription order based on the event including at least one of upcoming scheduled travel, extended travel days, or reduced travel days.

In some aspects, the techniques described herein relate to a mobile device, wherein the smart order controller is configured to cause the mobile device to modify the quantity of the item included in the subscription order based on at least one of a current geographic location of a delivery recipient relative to a delivery location of the subscription order, or an estimation of an arrival time of the delivery recipient to the delivery location based on the current geographic location of the delivery recipient.

In some aspects, the techniques described herein relate to a mobile device, wherein the smart order controller is configured to cause the mobile device to modify the subscription order based on the event including at least one of a detected health issue of a delivery recipient, a detected prescription to remove or add the item for consumption, or a detected dietary change of the delivery recipient.

In some aspects, the techniques described herein relate to a mobile device, wherein the smart order controller is configured to cause the mobile device to modify the subscription order based on the event including an ability of payment for the subscription order.

In some aspects, the techniques described herein relate to a mobile device, wherein the smart order controller is configured to cause the mobile device to permit transmission of the request to modify the quantity of the item included in the subscription order based on a determination that the transmission occurs prior to a cutoff time for modifying orders on the fulfillment service.

In some aspects, the techniques described herein relate to a mobile device, wherein the smart order controller is configured to cause the mobile device to permit transmission of the request to modify the quantity of the item included in the subscription order based on an approval from a delivery recipient in response to a notification and request to modify the subscription order.

In some aspects, the techniques described herein relate to a mobile device, wherein the smart order controller is configured to cause the mobile device to revert the subscription order to include default items and a respective default quantity of the default items based on a determination that the event no longer affects the subscription order and that sufficient time remains to modify the subscription order.

In some aspects, the techniques described herein relate to a server device configured to provide a fulfillment service, the server device including: at least one processor coupled with a memory; and a smart order controller implemented at least partially in hardware and configured to cause the server device to: receive, from a mobile device, a subscription order for one or more items; determine an event that affects a quantity of an item included in the subscription order; and transmit, to the mobile device, a request to modify the quantity of the item included in the subscription order based on the determination of the event.

In some aspects, the techniques described herein relate to a server device, wherein the determination that the event affects the quantity of the item is based on the item being perishable.

In some aspects, the techniques described herein relate to a server device, wherein the smart order controller is configured to cause the server device to modify the quantity of the item included in the subscription order based on the event including at least one of more people who will use or consume the item, or less people who will use or consume the item.

In some aspects, the techniques described herein relate to a server device, wherein the smart order controller is configured to cause the server device to modify the quantity of the item included in the subscription order based on the event including at least one of upcoming scheduled travel, extended travel days, or reduced travel days.

In some aspects, the techniques described herein relate to a server device, wherein the smart order controller is configured to cause the server device to modify the quantity of the item included in the subscription order based on at least one of a current geographic location of a delivery recipient relative to a delivery location of the subscription order, or an estimation of an arrival time of the delivery recipient to the delivery location based on the current geographic location of the delivery recipient.

In some aspects, the techniques described herein relate to a server device, wherein the smart order controller is configured to cause the server device to modify the subscription order based on the event including at least one of a detected health issue of a delivery recipient, a detected prescription to remove or add the item for consumption, or a detected dietary change of the delivery recipient.

In some aspects, the techniques described herein relate to a server device, wherein the smart order controller is configured to cause the server device to modify the subscription order based on the event including an ability of payment for the subscription order.

In some aspects, the techniques described herein relate to a method, including: transmitting a subscription order to a fulfillment service for one or more items; determining an event that affects a quantity of an item included in the subscription order; and transmitting, to the fulfillment service, a request to modify the quantity of the item included in the subscription order based on the determination of the event.

In some aspects, the techniques described herein relate to a method, wherein the determination that the event affects the quantity of the item is based on the item being perishable.

In some aspects, the techniques described herein relate to a method, further including modifying the quantity of the item included in the subscription order based on the event including at least one of more people who will use or consume the item, or less people who will use or consume the item.

What is claimed:

1. A mobile device, comprising:
at least one processor coupled with a memory; and
a smart order controller implemented at least partially in hardware and configured to cause the mobile device to:
transmit a subscription order to a fulfillment service for one or more items;
determine an event that affects a quantity of an item included in the subscription order; and
transmit, to the fulfillment service, a request to modify the quantity of the item included in the subscription order based on the determination of the event.

2. The mobile device of claim 1, wherein the determination that the event affects the quantity of the item is based on the item being perishable.

3. The mobile device of claim 1, wherein the smart order controller is configured to cause the mobile device to modify the quantity of the item included in the subscription order based on the event including at least one of more people who will use or consume the item, or less people who will use or consume the item.

4. The mobile device of claim 1, wherein the smart order controller is configured to cause the mobile device to modify the quantity of the item included in the subscription order based on the event including at least one of upcoming scheduled travel, extended travel days, or reduced travel days.

5. The mobile device of claim 1, wherein the smart order controller is configured to cause the mobile device to modify the quantity of the item included in the subscription order based on at least one of a current geographic location of a delivery recipient relative to a delivery location of the subscription order, or an estimation of an arrival time of the delivery recipient to the delivery location based on the current geographic location of the delivery recipient.

6. The mobile device of claim 1, wherein the smart order controller is configured to cause the mobile device to modify the subscription order based on the event including at least one of a detected health issue of a delivery recipient, a detected prescription to remove or add the item for consumption, or a detected dietary change of the delivery recipient.

7. The mobile device of claim 1, wherein the smart order controller is configured to cause the mobile device to modify the subscription order based on the event including an ability of payment for the subscription order.

8. The mobile device of claim 1, wherein the smart order controller is configured to cause the mobile device to permit transmission of the request to modify the quantity of the item included in the subscription order based on a determination that the transmission occurs prior to a cutoff time for modifying orders on the fulfillment service.

9. The mobile device of claim 1, wherein the smart order controller is configured to cause the mobile device to permit transmission of the request to modify the quantity of the item included in the subscription order based on an approval from a delivery recipient in response to a notification and request to modify the subscription order.

10. The mobile device of claim 1, wherein the smart order controller is configured to cause the mobile device to revert the subscription order to include default items and a respective default quantity of the default items based on a determination that the event no longer affects the subscription order and that sufficient time remains to modify the subscription order.

11. A server device configured to provide a fulfillment service, the server device comprising:
at least one processor coupled with a memory; and
a smart order controller implemented at least partially in hardware and configured to cause the server device to:
receive, from a mobile device, a subscription order for one or more items;
determine an event that affects a quantity of an item included in the subscription order; and
transmit, to the mobile device, a request to modify the quantity of the item included in the subscription order based on the determination of the event.

12. The server device of claim 11, wherein the determination that the event affects the quantity of the item is based on the item being perishable.

13. The server device of claim 11, wherein the smart order controller is configured to cause the server device to modify the quantity of the item included in the subscription order based on the event including at least one of more people who will use or consume the item, or less people who will use or consume the item.

14. The server device of claim 11, wherein the smart order controller is configured to cause the server device to modify the quantity of the item included in the subscription order based on the event including at least one of upcoming scheduled travel, extended travel days, or reduced travel days.

15. The server device of claim 11, wherein the smart order controller is configured to cause the server device to modify the quantity of the item included in the subscription order based on at least one of a current geographic location of a delivery recipient relative to a delivery location of the subscription order, or an estimation of an arrival time of the delivery recipient to the delivery location based on the current geographic location of the delivery recipient.

16. The server device of claim 11, wherein the smart order controller is configured to cause the server device to modify the subscription order based on the event including at least one of a detected health issue of a delivery recipient, a detected prescription to remove or add the item for consumption, or a detected dietary change of the delivery recipient.

17. The server device of claim 11, wherein the smart order controller is configured to cause the server device to modify the subscription order based on the event including an ability of payment for the subscription order.

18. A method, comprising:
transmitting a subscription order to a fulfillment service for one or more items;
determining an event that affects a quantity of an item included in the subscription order; and
transmitting, to the fulfillment service, a request to modify the quantity of the item included in the subscription order based on the determination of the event.

19. The method of claim 18, wherein the determination that the event affects the quantity of the item is based on the item being perishable.

20. The method of claim 18, further comprising modifying the quantity of the item included in the subscription order based on the event including at least one of more people who will use or consume the item, or less people who will use or consume the item.
